(19) United States
(12) Patent Application Publication
(10) Pub. No.: US 2005/0013268 A1
(43) Pub. Date: Jan. 20, 2005

(54) Method for registering broadcast/multicast service in a high-rate packet data system

(76) Inventors: Yong Chang, Seongnam-si (KR); Jun-Hyuk Song, Anyang-si (KR); Nae-Hyun Lim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/889,112

(22) Filed: Jul. 13, 2004

(30) Foreign Application Priority Data
Jul. 14, 2003 (KR) 2003-47921

(51) Int. Cl. H04Q 7/00

(52) U.S. Cl. 370/328

(57) ABSTRACT

A method for registering Broadcast/Multicast Service (BCMCS) in a mobile broadcasting system including an access terminal, a BCMCS server for providing a BCMCS service to the access terminal, and a mobile communication system connected to the BCMCS server. The access terminal exchanges information, necessary for BCMCS setup, with a BCMCS controller connected to the BCMCS server during a state wherein a session to the mobile communication system is set up. Upon receiving a BCMCS overhead from an access network in the mobile communication system, the access terminal transmits a message, including BCMCS identification information for a desired BCMCS service, to the access network. Upon receiving the message, the access network transmits a BCMCS connect setup message to a packet control function in the mobile communication system. Upon receiving the BCMCS connect setup message, the packet control function then transmits a registration message, including BCMCS information, to a packet data service node in the mobile communication system.

### CROSS-REFERENCE TO RELATED APPLICATIONS

This application claims the benefit under 35 U.S.C. § 119(a) of Korean Patent Application No. 2003-47921 entitled “Method for Registering Broadcast/Multicast Service in a High-Rate Packet Data. System”, filed in the Korean Intellectual Property Office on Jul. 14, 2003, the entire contents of which are incorporated herein by reference.

### BACKGROUND OF THE INVENTION

1. Field of the Invention

The present invention relates generally to a mobile communication system. More particularly, the present invention relates to a Broadcast/Multicast Service (BCMCS) method in a high-rate packet data system.

2. Description of the Related Art

With the development of communication technology, various technologies for combining a packet-based network using Internet Protocol (IP) with a wireless communication network are being studied. Code Division Multiple Access (CDMA) is the most typical of these technologies. In the CDMA system, voice or data received from a wireless communication network is transferred to a packet-based IP network using an IP packet such that the packet is finally received at an access terminal, or a mobile node or a mobile host, having an IP address.

An International Mobile Telecommunications-2000 (IMT-2000) system, one such CDMA system, is a next generation mobile communication system with a goal of integrating specifications for various mobile communication systems currently operating separately in respective nations in order to enable a user to receive a communication service in any place in the world. The IMT-2000 system can access various services through one access terminal (AT). For example, a user can perform a video conference while also performing Internet/Intranet graphic access, multimedia mail exchange, mass data/file transfer, and the like. In addition, the IMT-2000 system provides global roaming, wireless video service, video remote conference, interactive entertainment, and similar services.

Generally, such a mobile communication system communicates with one access terminal in a unicast scheme in order to transfer packet data. That is, the mobile communication system designates an address of a particular user to achieve an incoming/outgoing data call, and an access network assigns a band for data transmission to the corresponding user to provide a service.

However, the unicast scheme results in resource waste in a network and a radio section, and also results in an increase in system load when the same data is simultaneously transmitted to a plurality of users. Accordingly, a need exists for a new technique for providing the existing data service to users desiring to receive the same service, or a so-called Broadcast/Multicast Service (BCMCS), while conserving resources.

In a high-rate packet data system providing the BCMCS, in order to receive specific broadcasting contents desired by a user, it is necessary to set a procedure for registering the broadcasting contents in a corresponding content of BCMCS such that the user can receive a corresponding BCMCS.

In BCMCS, a service provider considers user authentication and accounting services for each service with a high degree of importance. Therefore, in order to bill a user receiving a corresponding BCMCS, a procedure is required for informing the system of a reception start time and a reception end time of the corresponding contents.

Accordingly, a need exists for a broadcasting contents encryption function for enabling only authorized users to receive broadcasting contents. Decryption information can then be transmitted such that a user can decrypt the encrypted broadcasting contents.

### SUMMARY OF THE INVENTION

It is, therefore, an object of the present invention to provide a method for transmitting decryption information needed for service registration and contents reception to an access terminal to provide broadcasting contents desired by a user.

To achieve the above and other objects in accordance with embodiment of the present invention, a method is provided for registering Broadcast/Multicast Service (BCMCS) by an access network in a high-rate packet data system including an access network (AN) for performing radio communication with an access terminal (AT), a packet control function (PCF) for processing packet data communication, and a packet data service node (PDSN) connected to a BCMCS contents server (CS) via a packet communication network. The method comprises receiving a registration message including BCMCS information for registration request of a BCMCS service from the access terminal; transmitting a BCMCS setup message including the BCMCS information for setup of the packet data service node to the packet control function; and receiving a BCMCS connect message from the packet control function as a response for the setup process.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a system configuration example for providing a BCMCS service according to an embodiment of the present invention;

FIG. 2 is a message flow diagram illustrating a method for registering a BCMCS service according to a first embodiment of the present invention;

FIG. 3A is a diagram illustrating an A9-BCMCS Setup-A8 message according to an embodiment of the present invention;

FIG. 3B is a diagram illustrating detailed fields of added parameters in the A9-BCMCS Setup-A8 message according to an embodiment of the present invention;

FIG. 4A is a diagram illustrating an A11-BCMCS Registration Request message according to an embodiment of the present invention;

FIG. 4B is a diagram illustrating detailed structure of an NVSE field according to an embodiment of the present invention;

FIG. 4C is a diagram illustrating an Application Type list of the NVSE according to an embodiment of the present invention;

FIG. 5 is a diagram illustrating an A11-BCMCS Registration Reply message according to an embodiment of the present invention;

FIG. 6 is a diagram illustrating an A11-BCMCS Registration Reply Ack message according to an embodiment of the present invention;

FIG. 7A is a diagram illustrating an A9-BCMCS Connect-A8 message according to an embodiment of the present invention;

FIG. 7B is a diagram illustrating detailed fields of added parameters in the A9-BCMCS Connect-A8 message according to an embodiment of the present invention;

FIG. 8 is a diagram illustrating an A9-BCMCS Connect Ack-A8 message according to an embodiment of the present invention;

FIG. 9 is a message flow diagram illustrating a procedure for registering a BCMCS service according to a second embodiment of the present invention; and

FIG. 10 is a diagram illustrating an A11-BCMCS Registration Reply message according to the second embodiment of the present invention.

In the above figures, like reference numbers are used to refer to like features and structures.

### DETAILED DESCRIPTION OF THE EXEMPLARY EMBODIMENTS

Several exemplary embodiments of the present invention will now be described in greater detail with reference to the annexed drawings. In the drawings, the same or similar elements are denoted by the same reference numerals even though they are depicted in different drawings. In the following description, a detailed description of known functions and configurations incorporated herein has been omitted for conciseness.

The present invention provides a method for registering specific broadcasting contents desired by a user into a corresponding content BCMCS to allow the user to receive the specific broadcasting contents. The present invention further provides a method for transmitting decryption information needed during content reception in a high-rate packet data system. The decryption information can be comprised of a decryption key (XMask) and a decryption key sequence number (XMask Seq#). By defining a BCMCS registration method, it is possible to register a user receiving the broadcasting contents, generate accounting information for a BCMCS service used, and provide handoff during BCMCS reception.

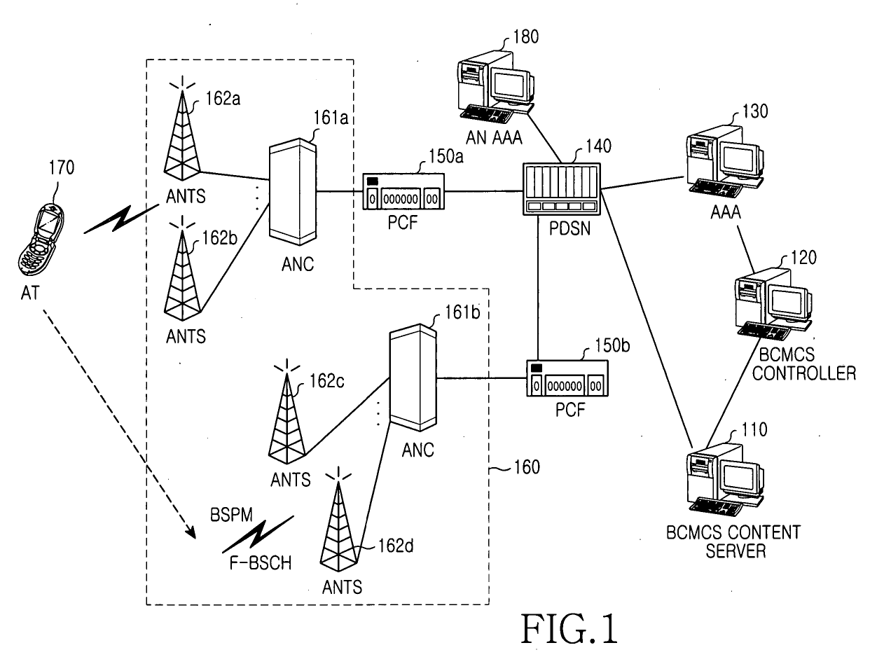

FIG. 1 is a diagram illustrating a system configuration example for providing a BCMCS service according to an embodiment of the present invention. Referring to FIG. 1, a BCMCS server 110, or a contents server, includes broadcast data such as video and sound for a BCMCS service. The BCMCS server 110 generates the broadcast data in the form of a compressed IP packet, and delivers the IP packet to an access network (AN) 160 via a packet communication network such as the Internet.

The access network 160 is comprised of access network transceiver subsystems (ANTSs) 162a, 162b, 162c and 162d, and access network controllers (ANCs) 161a and 161b, which are well known to those skilled in the art in the technical filed of mobile communication. In the example shown in FIG. 1, the packet communication network is comprised of a packet data service node (PDSN) 140 and packet control functions (PCFs) 150a and 150b. The packet data service node 140 manages a user profile and provides a BCMCS service to an access terminal (AT) 170.

The packet data service node 140 is connected to an Authentication, Authorization and Accounting (AAA) server 180 for controlling authentication of the access terminal 170 and an AAA server 130 for controlling authentication of broadcasting and charging.

A BCMCS controller 120 is connected to the BCMCS server 110 and controls communication between the BCMCS server 110 and the access terminal 170. Although only one BCMCS server 110 is illustrated herein for simplicity, a plurality of BCMCS servers can be connected to the BCMCS controller 120.

IP Multicast can be used to transfer broadcast data generated by the BCMCS server 110 to the packet data service node 140, and the conventional CDMA2000 access network technology can be used to transfer the broadcast data from the packet data service node 140 to the access network 160. The packet data service node 140 forms a Multicast Group receiving IP multicast data from the BCMCS server 110. Membership information of the Multicast Group is maintained by a multicast router (MR) (not shown) connected to the packet data service node 140. The packet data service node 140 is connected to a domain name system (DNS) (not shown) that manages addresses.

IP data including video and sound generated by the BCMCS server 110 is broadcast to packet data service nodes 140 that form a Multicast Group, or is unicast to each packet data service node 140. Further, each packet data service node 140 then delivers IP data to the access network 160, and the access network transceiver subsystems 162a, 162b, 162c and 162d convert the IP data into a radio frequency (RF) signal and transmit the RF signal in their service areas.

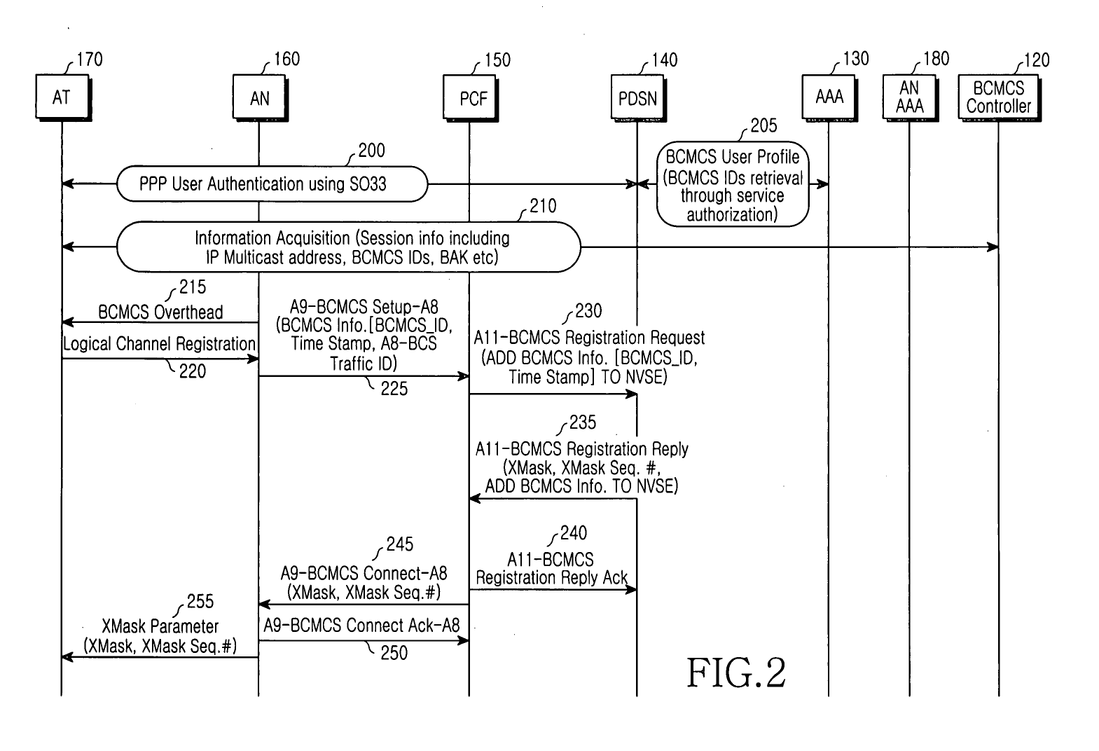

With reference to FIGS. 2 through 10, a description will now be made of a method for registering specific broadcasting contents desired by a user into a corresponding content BCMCS allowing the user to receive the specific broadcasting contents. A method for transmitting a decryption key (XMask) needed during contents reception in the high-rate packet data system is also described in greater detail below.

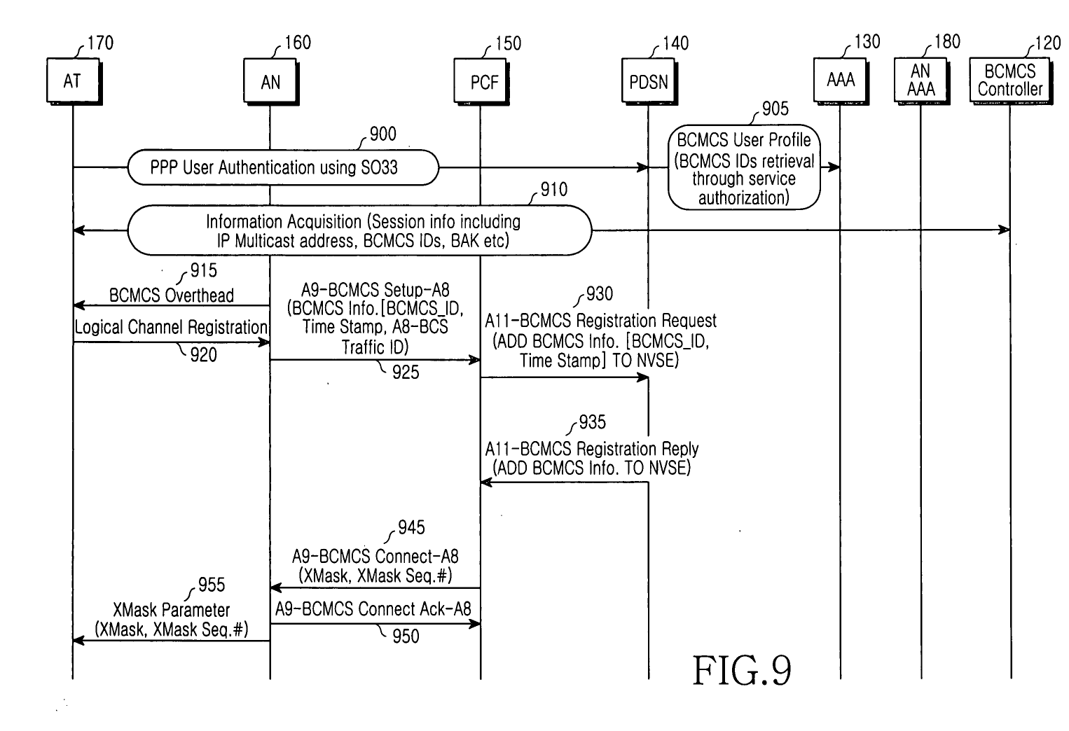

FIGS. 2 and 9 are message flow diagrams according to first and second embodiments of the present invention. A partial description of the second embodiment in FIG. 9, which is identical to a corresponding description of the first embodiment in FIG. 2, will be omitted herein for simplicity.

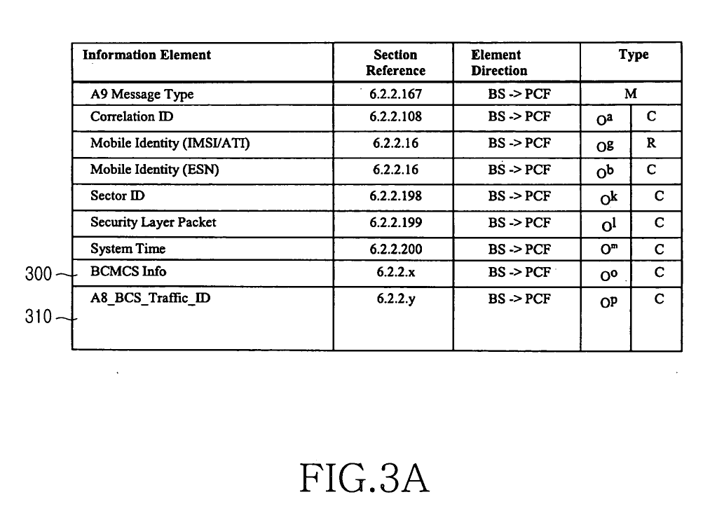

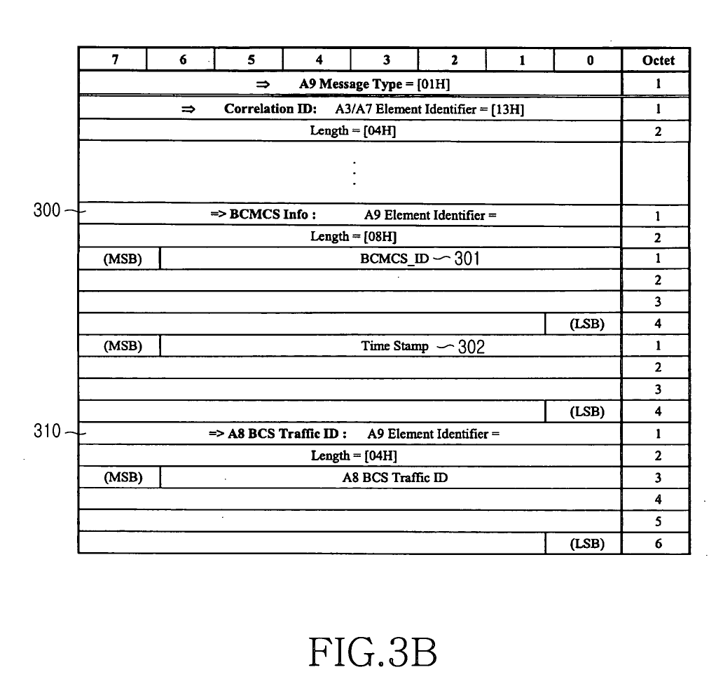

FIGS. 3A through 8, and FIG. 10 are diagrams illustrating messages used in accordance with embodiments of the present invention. For simplicity, only the parameters and elements added to provide a BCMCS service in the present invention among the information elements illustrated in the drawings will be described, and the remaining information elements will be omitted herein for simplicity.

### First Embodiment

With reference to FIG. 2, a description will be made of a method for generating and transmitting a decryption key by a packet data service node 140 according to a first embodiment of the present invention.

FIG. 2 is a message flow diagram illustrating a method for registering a BCMCS service according to the first embodiment of the present invention. Referring to FIG. 2, in step 200, an access terminal (AT) 170 sets up a Point-to-Point Protocol (PPP) session for a BCMCS service with a packet data service node (PDSN) 140. The packet data service node (PDSN) 140 manages a user profile selected as an International Mobile Subscriber Identity (IMSI) of the access terminal 170 by a packet control function (PCF) 150.

In step 205, an AAA server 130 receiving an access request from the packet data service node 140, retrieves a user profile for BCMCS authentication, and transmits an authenticated BCMCS_ID to the packet data service node 140. The packet data service node 140 then stores the BCMCS_ID, or the authentication information, in association with a corresponding access terminal, and then informs the access terminal 170 of the successful PPP session setup. As the PPP session is set up, the access terminal 170 receives broadcasting session information necessary for BCMCS watching in step 210, including IP Multicast Address, BCMCS_ID, BAK (BCMCS Authentication Key), and the like, from a BCMCS controller 120.

In step 215, an access network (AN) 160 transmits a BCMCS Overhead message through a Broadcast Service Parameter Message (BSPM), and through this message, the access terminal 170 considers whether to perform a handoff and determine contents of BCMCS.

In step 220, the access terminal 170 desiring to receive a BCMCS service, transmits a Logical Channel Registration message including a corresponding BCMCS-ID to the access network 160.

In step 225, the access network 160 receiving the Logical Channel Registration message, transmits an A9-BCMCS Setup-A8 message for A8-broadcasting connection setup with the packet control function 150 to the packet control function 150.

FIG. 3A is a diagram illustrating an example of the A9-BCMCS Setup-A8 message. Referring to FIG. 3A, in the A9-BCMCS Setup-A8 message, parameters added by the present invention include BCMCS Info 300 and A8-BCS Traffic ID 310 for BCMCS transmission.

Detailed fields of the added parameters are illustrated in FIG. 3B. Referring to FIG. 3B, the BCMCS info 300 includes BCMCS_ID 301 indicating broadcasting contents, and Time Stamp 302 for accounting.

The BCMCS_ID 301 indicates the contents that the access terminal 170 desires to receive, and this is transmitted in step 220 through the Logical Channel Registration message. The Time Stamp 302 indicates a time when a registration message from the access terminal 170 is received at an access network controller 161, and is used for accounting. The A8-BCS Traffic ID 310 provides a route through which broadcasting contents can be transmitted to be distinguished from a general Data-Only service. Corresponding information includes GRE (Gemeric Routing Encapsulation) Key/Port Number.

Returning to FIG. 2, in step 230, the packet control function 150 receiving the A9-BCMCS Setup-A8 message transmits an A11-BCMCS Registration Request message including BCMCS Info to the packet data service node 140.

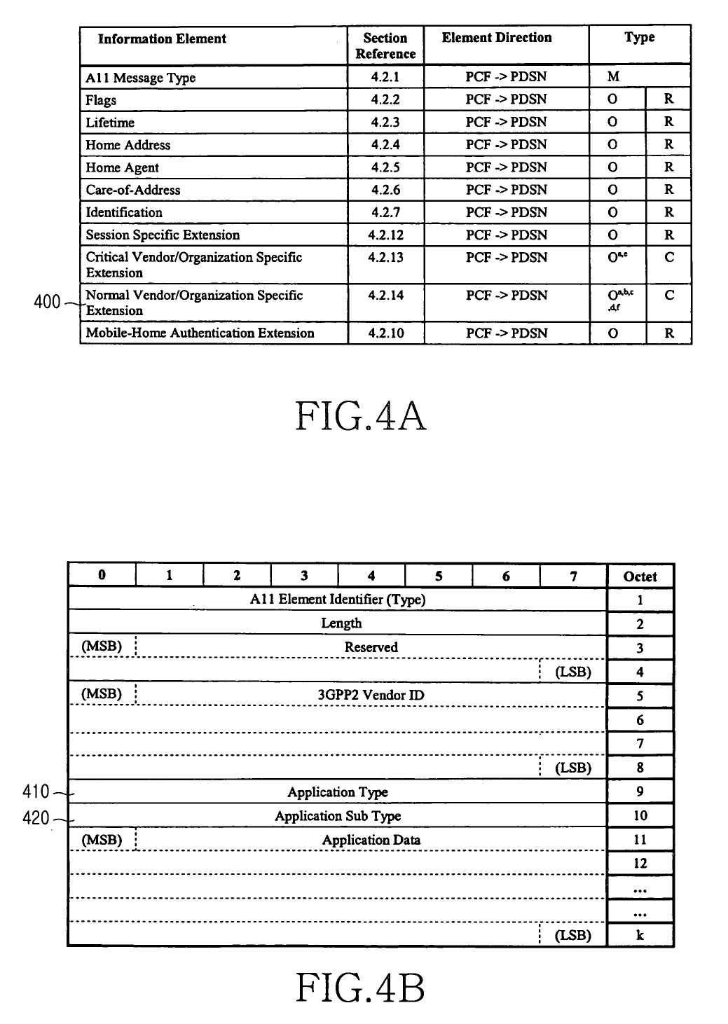

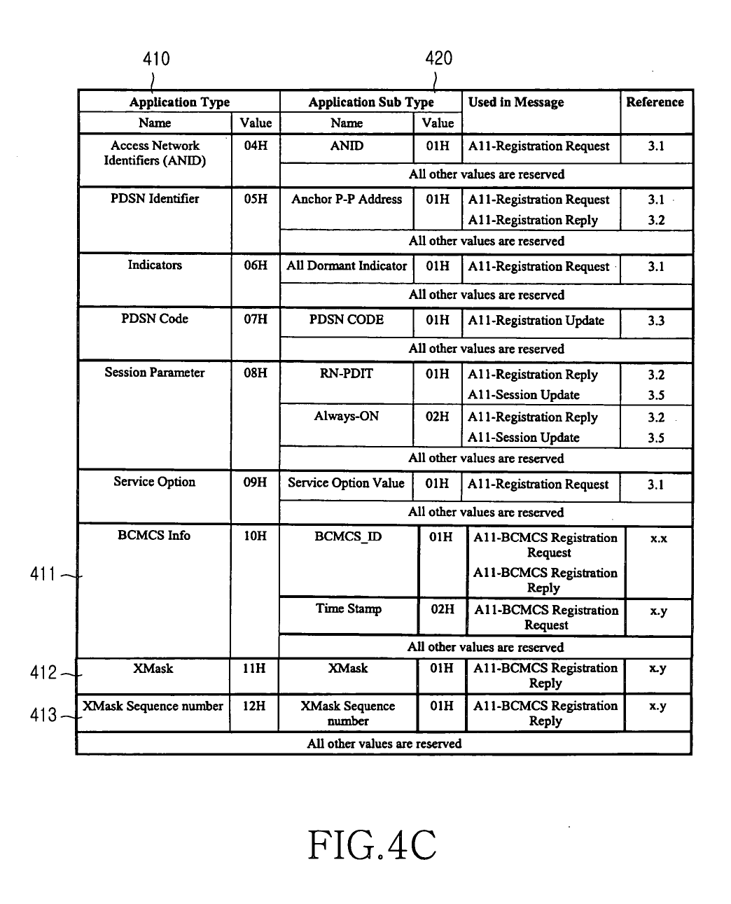

FIG. 4A is a diagram illustrating an example of the All-BCMCS Registration Request message. In the A11-BCMCS Registration Request message, a parameter added by the present invention includes the BCMCS Info transmitted at step 230. As described with reference to FIG. 3B, the BCMCS Info transmits the contents that the user desires to listen to, and accounting information.

The added parameter is transmitted over a Normal Vendor/Organization Specific Extension (NVSE) field 400 as shown in FIG. 4A, and a detailed structure of the NVSE field 400 is illustrated in FIG. 4B. FIG. 4C illustrates a list of the Application Type 410 and Application Sub Type 420 from FIG. 4B, and which is set such that the transmitted BCMCS Info should be added.

Returning to FIG. 2, in step 235, the packet data service node 140 receiving the All-BCMCS Registration Request message, transmits an A11-BCMCS Registration Reply message to the packet control function 150.

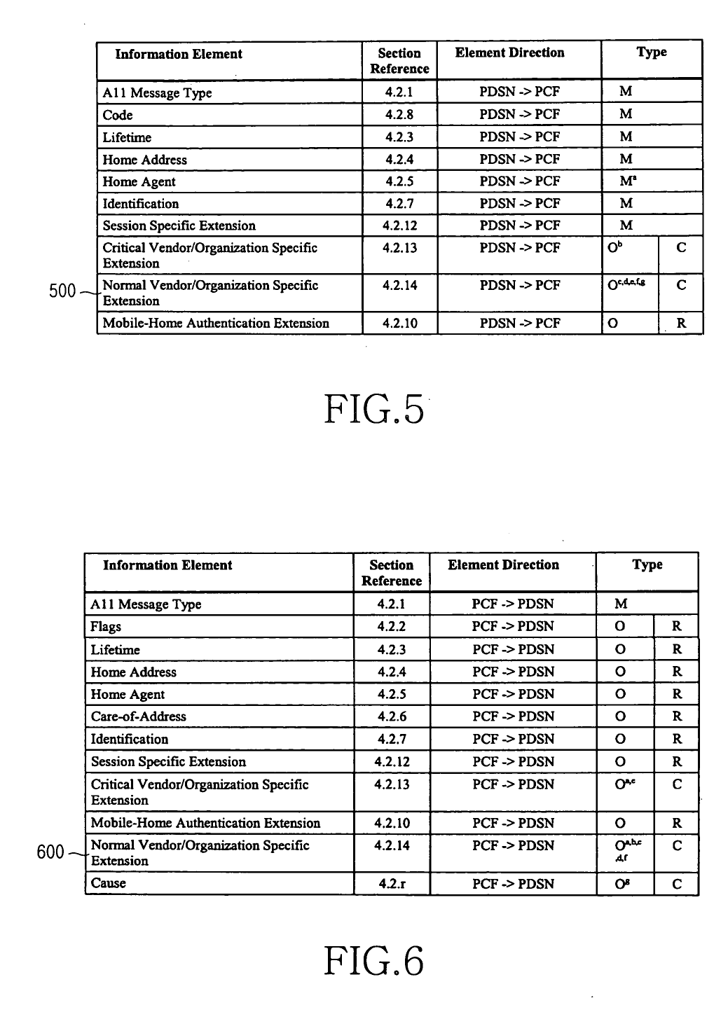

FIG. 5 is a diagram illustrating an example of the A11-BCMCS Registration Reply message. Referring to FIG. 5, in the A11-BCMCS Registration Reply message, parameters added by the present invention are transmitted over the NVSE 500.

The added parameters include available BCMCS_ID, decryption key (XMask), or decryption information, and decryption key sequence number (XMask Seq#). The decryption key (XMask) is used for decrypting received encrypted broadcasting contents by the access terminal 170 in order to block an unauthorized user. The decryption key sequence number (XMask Seq#) is used for reducing a possible data loss during a change of the decryption key (XMask). For this, the Application Type illustrated in FIG. 4B is set such that the BCMCS_ID, decryption key (XMask) 412, and decryption key sequence number (XMask Seq#) 413 in the list of FIG. 4C should be added.

Returning to FIG. 2, in step 240, the packet control function 150 receiving the decryption key (XMask) and the decryption key sequence number (XMask Seq#) transmits an A11-BCMCS Registration Reply Ack message to the packet data service node 140 in acknowledgement of the A11-BCMCS Registration Reply message received in step 235.

FIG. 6 is a diagram illustrating an example of the A11-BCMCS Registration Reply Ack message. The A11-BCMCS Registration Reply Ack message illustrated in FIG. 6 is not defined in the current 1x and DO. Conventionally, 2-way signaling was used, but information elements included in the A11-BCMCS Registration Reply Ack message are newly proposed to determine whether XMask proposed in the present invention is successfully transmitted.

Returning to FIG. 2, in step 245, the packet control function 150 receiving the BCMCS Info, description key (XMask) and decryption key sequence number (XMask Seq#) transmits the received message to the access network 160 using an A9-BCMCS Connect-A8 message.

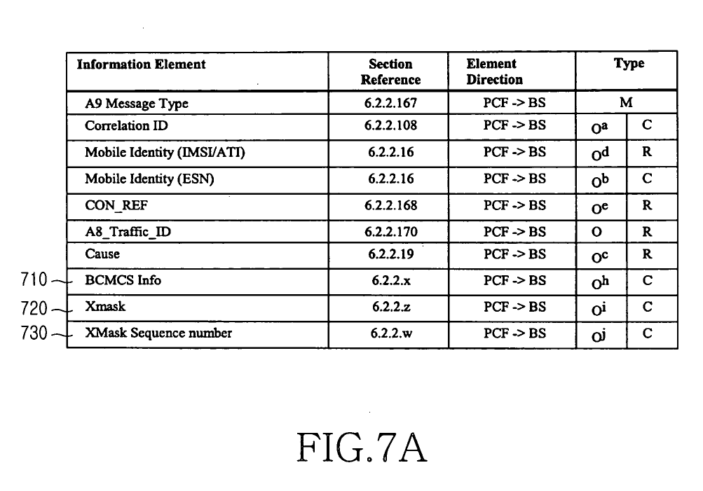

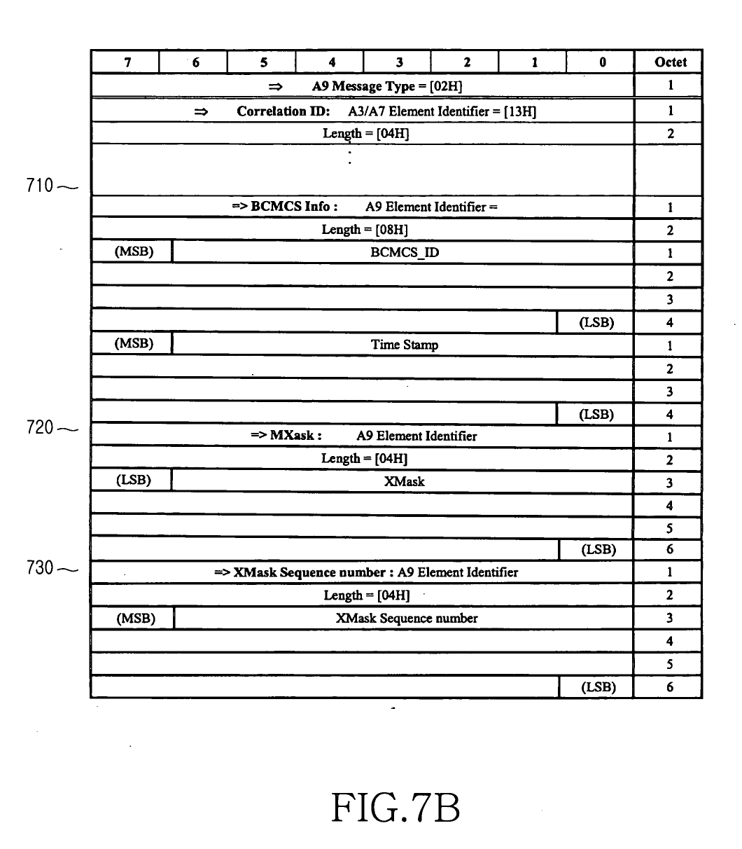

FIG. 7A is a diagram illustrating an example of the A9-BCMCS Connect-A8 message. Referring to FIG. 7A, in the A9-BCMCS Connect-A8 message, parameters added by the present invention include BCMCS Info 710, description key (XMask) 720 and decryption key sequence number (XMask Seq#) 730 received in step 235. FIG. 7B is a diagram illustrating detailed fields of the BCMCS Info 710, the description key (XMask) 720 and the decryption key sequence number (XMask Seq#) 730.

The description key (XMask) is provided for decrypting received encrypted broadcasting contents by the access terminal. The decryption key sequence number (XMask Seq#) serves to indicate the description key (XMask) that should be checked subsequently due to a characteristic of the description key (XMask) which is periodically changed. By doing so, it is possible to prevent a possible data loss.

Returning to FIG. 2, in step 250, the access network 160 receiving the decryption key (XMask) and the decryption key sequence number (XMask Seq#) delivers an A9-BCMCS Connect Ack-A8 message to the packet control function 150.

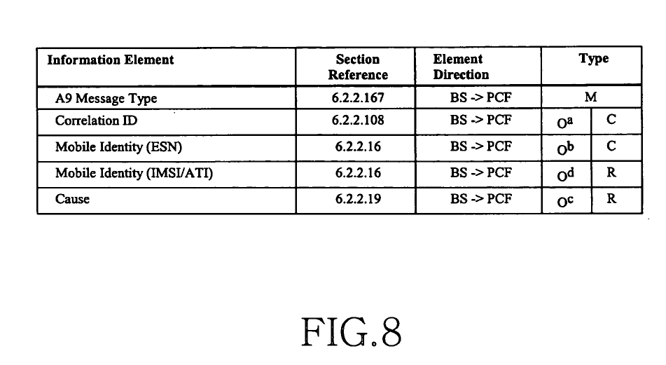

FIG. 8 is a diagram illustrating an example of the A9-BCMCS Connect Ack-A8 message. The A9-BCMCS Connect Ack-A8 message is not defined in the current 1x and DO. Therefore, information elements included in the A9-BCMCS Connect Ack-A8 message used for broadcasting can be newly added by the present invention, for the same purpose as the All-BCMCS Registration Reply Ack message.

Returning to FIG. 2, in step 255, the access network 160 receiving the decryption key (XMask) delivers the received decryption key (XMask) to the access terminal 170 using an XMask Parameter message. Then the access terminal 170 decrypts received broadcasting contents using the received decryption key (XMask).

### Second Embodiment

With reference to FIG. 9, a description will be made of a method for generating and transmitting a decryption key by a packet control function 150 according to a second embodiment of the present invention.

FIG. 9 is a message flow diagram illustrating a method for registering a BCMCS service according to the second embodiment of the present invention. As steps 900 to 930 of FIG. 9 are identical in operation to the steps 200 to 230 of FIG. 2, a detailed description thereof will be omitted.

In step 935, the packet data service node 140 receiving the A11-BCMCS Registration Request message transmits an A11-BCMCS Registration Reply message to the packet control function 150.

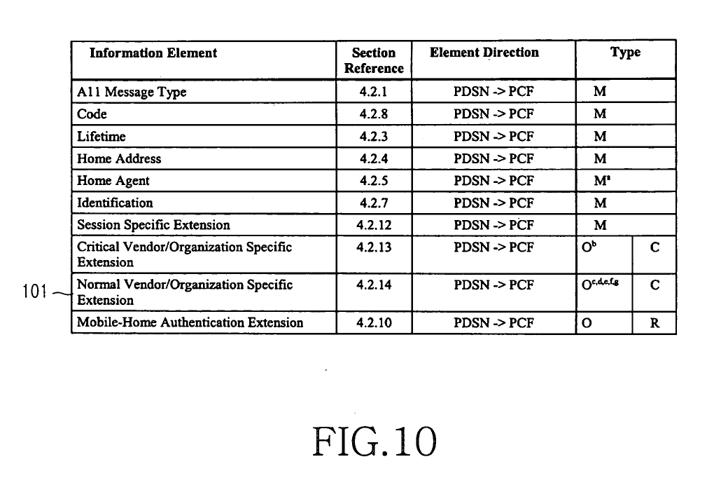

FIG. 10 is a diagram illustrating an example of the A11-BCMCS Registration Reply message in accordance with the second embodiment of the present invention. Referring to FIG. 10, in the A11-BCMCS Registration Reply message, BCMCS Info is provides as a newly added parameter to be transmitted by NVSE 500.

In the first embodiment, because the decryption key is generated by the packet data service node 140, the decryption key (XMask) and the decryption key sequence number (XMask Seq#) are added in step 235 as described in conjunction with FIG. 5. However, in the second embodiment, because the decryption key (XMask) is generated by the packet control function 150, the decryption key (XMask) and the decryption key sequence number (XMask Seq#) are not added in step 935.

In step 945, the packet control function 150 receiving the BCMCS Info, includes the received message in an A9-BCMCS Connect-A8 message, adds a decryption key (XMask) and a decryption key sequence number (XMask Seq#) thereto, and then delivers the A9-BCMCS Connect-A8 message to the access network 160.

Referring again to FIG. 7A, which is a diagram illustrating an example of the A9-BCMCS Connect-A8 message, parameters added by the present invention include BCMCS Info 710 received in step 935, and description key (XMask) 720 and decryption key sequence number (XMask Seq#) 730 added by the packet control function 150. FIG. 7B is a diagram illustrating detailed fields of the BCMCS Info 710, the description key (XMask) 720 and the decryption key sequence number (XMask Seq#) 730.

Because steps 950 and 955 are identical in operation to the steps 250 and 255 of FIG. 2, a detailed description thereof will be omitted.

As described above, the present invention relates to a method for registering specific broadcasting contents desired by a user into a corresponding content BCMCS to allow the user to receive the specific broadcasting contents, and a method for transmitting decryption information needed during contents reception in the high-rate packet data system. By defining the BCMCS registration procedure in this manner, it is possible to register a user receiving the broadcasting contents, generate accounting information for a BCMCS service used, and provide handoff during BCMCS reception.

While the invention has been shown and described with reference to certain exemplary embodiments thereof, it will be understood by those skilled in the art that various changes in form and details may be made therein without departing from the spirit and scope of the invention as defined by the appended claims.

1. A method for registering Broadcast/Multicast Service (BCMCS) in a high-rate packet data system including an access network (AN) for performing radio communication with an access terminal (AT), a packet control function (PCF) for processing packet data communication, and a packet data service node (PDSN) connected to a BCMCS contents server (CS) via a packet communication network, the method comprising the steps of:
receiving, by the access network, a registration message including BCMCS information for registration request of a BCMCS service from the access terminal;
transmitting, by the access network, a BCMCS setup message including the BCMCS information for setup of the packet data service node to the packet control function; and
receiving, by the access network, a BCMCS connect message from the packet control function as a response for the setup process.

2. The method of claim 1, wherein the BCMCS information includes BCMCS identification (ID) for identifying the setup-requested BCMCS service.

3. The method of claim 2, wherein the BCMCS information further includes a time stamp representing a time when the access network received the BCMCS setup message.

4. The method of claim 1, wherein the BCMCS connect message includes decryption information comprised of a decryption key which is decryption information for contents and a decryption key sequence number for distinguishing decryption key values which are periodically changed.

5. The method of claim 4, wherein the decryption information is generated by the packet control function.

6. The method of claim 1, further comprising the step of transmitting a BCMCS connect acknowledge message to the packet control function in acknowledgement of the BCMCS connect message.

7. A method for setting up Broadcast/Multicast Service (BCMCS) in a high-rate packet data system including an access network (AN) for performing radio communication with an access terminal (AT), a packet control function (PCF) for processing packet data communication, and a packet data service node (PDSN) connected to a BCMCS contents server (CS) via a packet communication network, the method comprising the steps of:
receiving, by the packet control function, a BCMCS setup message for setup of a BCMCS service from the access network;
transmitting, by the packet control function, a BCMCS registration request message including BCMCS information for setup to the packet data service node; and
receiving, by the packet control function, a BCMCS registration reply message from the packet data service node as a response for the setup process; and
transmitting, by the packet control function, BCMCS connect message informing the setup of the BCMCS service to the access network

8. The method of claim 7, wherein the BCMCS information includes BCMCS identification (ID) for identifying the setup-requested BCMCS service.

9. The method of claim 8, wherein the BCMCS information further includes a time stamp representing a start time of a BCMCS service.

10. The method of claim 7, wherein the BCMCS information is included in application fields in a normal vendor/organization specific extension field constituting the BCMCS registration request message.

11. The method of claim 7, wherein the BCMCS connect message includes decryption information comprised of a decryption key which is decryption information for contents and a decryption key sequence number for distinguishing decryption key values which are periodically changed.

12. The method of claim 11, wherein the decryption information is generated by the packet control function.

13. The method of claim 11, wherein the decryption information is generated by the packet data service node and included in the BCMCS registration message.

14. The method of claim 7, further comprising the step of transmitting a BCMCS registration reply acknowledge message to the packet control function in acknowledgement of a BCMCS connect message.

15. A method for setting up Broadcast/Multicast Service (BCMCS) in a high-rate packet data system including an access network (AN) for performing radio communication with an access terminal (AT), a packet control function (PCF) for processing packet data communication, and a packet data service node (PDSN) connected to a BCMCS contents server (CS) via a packet communication network, the method comprising the steps of:
receiving by the access network a registration message for setup request of a BCMCS service from the access terminal;
transmitting by the access network a BCMCS setup message including BCMCS information for a setup-requested BCMCS service to the packet control function;
transmitting by the packet control function a BCMCS registration request message including the BCMCS information to the packet data service node;
performing, by the packet data service node, a setup process on a corresponding BCMCS service based on the BCMCS information;
transmitting by the packet data service node a BCMCS registration reply message to the packet control function in response to the BCMCS registration request message;
transmitting by the packet control function a BCMCS connect message indicting completion of the setup process, to the access network; and
transmitting by the access network a message indicating the connect of the BCMCS service, to the access terminal.

16. The method of claim 15, further comprising the step of performing by the packet data service node an accounting process on a BCMCS service provided to a corresponding access terminal based on the BCMCS information.

17. The method of claim 15, wherein the BCMCS information includes BCMCS identification (ID) for identifying the setup-requested BCMCS service.

18. The method of claim 17, wherein the BCMCS information further includes a time stamp representing a start time of a BCMCS service.

19. The method of claim 15, wherein the BCMCS connect message includes decryption information comprised of a decryption key which is decryption information for contents and a decryption key sequence number for distinguishing decryption key values which are periodically changed.

20. The method of claim 19, wherein the decryption information is generated by the packet control function.

21. The method of claim 19, wherein the decryption information is generated by the packet data service node and included in the BCMCS registration reply message.

22. A broadcasting service system for setting up Broadcast/Multicast Service (BCMCS) in response to a request from an access terminal in a high-rate packet data system, comprising:
an access network for performing radio communication with the access terminal, and transmitting a BCMCS setup message including BCMCS information for a registration-requested BCMCS service to a packet control function up receiving a registration message for setup request of a BCMCS service from the access terminal; and
a packet data service node for performing a setup and accounting process on a corresponding BCMCS service based on the BCMCS service if a BCMCS registration request message including the BCMCS information is received from the packet control function that received the BCMCS setup message.

23. The broadcasting service system of claim 22, wherein the BCMCS information includes BCMCS identification (ID) for identifying the setup-processed BCMCS service and a time stamp for the accounting process.
